(19) United States
(12) Patent Application Publication
(10) Pub. No.: US 2025/0131795 A1
(43) Pub. Date: Apr. 24, 2025

(54) DOUBLE PERCEIVED PERSISTENCE PRESENTATION

(71) Applicant: IGT, Las Vegas, NV (US)

(72) Inventor: Klaus Hufnagl-Abraham, Graz (AT)

(21) Appl. No.: 18/383,322

(22) Filed: Oct. 24, 2023

(51) Int. Cl. G07F 17/32

(52) U.S. Cl. CPC G07F 17/3258; G07F 17/3211

(57) ABSTRACT

Embodiments of the present disclosure are directed to providing indications of persistence in an electronic game. More specifically, embodiments of the present disclosure are directed to providing representations of a state of a progressive award, e.g,. a jackpot, of the electronic game. The representation of a state of a progressive award can persistently present an indication of an amount of time since the award was last won. The representation of a state of a progressive award can also persistently present an indication of an amount or size of the progressive award. Both of these presentations can be made in a manner that relates to the game itself, e.g., by symbols used and animations presented to update the presentations. This can build excitement about and interest in the game thereby increasing player involvement, encouraging game player, and increasing revenues of the game.

### BACKGROUND

The present disclosure is generally directed to operating an electronic game, and more particularly to providing indications of persistence in an electronic game.

In a casino environment, games which provide a story, a sense of progression towards an award such as a jackpot, and/or an impression of a size of the jackpot can increase player engagement. Increased player engagement in turns leads to increased use of the game and revenues for the operator of the casino. Thus, there is a need to provide a sense of progress and/or an impression of persistence as the game progresses toward a win of the jackpot, especially in a way that connects to the game in an entertaining way.

### BRIEF SUMMARY

Embodiments of the present disclosure are directed to providing indications of persistence in an electronic game. According to one embodiment, a method for operating an electronic game can comprise executing an electronic game having a progressive award and presenting a representation of the electronic game. The representation of the electronic game can comprise a plurality of features with each feature of the plurality of features comprising a plurality of graphical symbols. A representation of a state of the progressive award can also be presented. The representation of the state of the progressive award can comprise a first selected symbol. The first selected symbol can comprise a same symbol as one of the plurality of symbols of the plurality of features. A number of the first selected symbol presented in the representation of the state of the progressive award can indicates an amount of time since the progressive award was last awarded. An occurrence of a first predefined event within the electronic game can be detected. In response to detecting the occurrence of the first predefined event within the electronic game, the presented representation of the state of the progressive award and the presented representation of the electronic game can be updated with an animation of the first selected symbol moving from one of the plurality of features of the presented representation of the electronic game to the presented representation of the state of the progressive award.

In some cases, the representation of the state of the progressive award can further comprise a second selected symbol. A number of the second selected symbol presented in the representation of the state of the progressive award can indicate an award amount for the progressive award. An increase in the award amount for the progressive award can be detected. In response to detecting the increase in the award amount for the progressive award, updating the presented representation of the state of the progressive award with an instance of the second selected symbol.

In some cases, a second predefined event within the electronic game can be detected. In response to detecting the occurrence of the second predefined event within the electronic game, the presented representation of the state of the progressive award and the presented representation of the electronic game can be updated with an animation of the first selected symbol moving from the presented representation of the state of the progressive award to one of the plurality of features of the presented representation of the electronic game. For example, detecting the occurrence of the first predefined event is based on a first random number and detecting the occurrence of the second predefined event is based on a second random number, wherein the occurrence of the first predefined event is more likely than the occurrence of the second predefined event.

According to another embodiment, a system can comprise a display device, a processor coupled with the display device, and a memory coupled with and readable by the processor. The memory can have stored therein a set of instructions which, when executed by the processor, causes the processor to execute an electronic game having a progressive award and present a representation of the electronic game. The representation of the electronic game can comprise a plurality of features, each feature of the plurality of features comprising a plurality of graphical symbols. The instructions can further cause the processor to present a representation of a state of the progressive award. The representation of the state of the progressive can comprise a first selected symbol, the first selected symbol comprising a same symbol as one of the plurality of symbols of the plurality of features. A number of the first selected symbol presented in the representation of the state of the progressive award indicates an amount of time since the progressive award was last awarded.

The instructions can further cause the processor to detect an occurrence of a first predefined event within the electronic game and in response to detecting the occurrence of the first predefined event within the electronic game, update the presented representation of the state of the progressive award and the presented representation of the electronic game with an animation of the first selected symbol moving from one of the plurality of features of the presented representation of the electronic game to the presented representation of the state of the progressive award. The representation of the state of the progressive award can further comprise a second selected symbol and a number of the second selected symbol presented in the representation of the state of the progressive award can indicate an award amount for the progressive award. The instructions can further cause the processor to detect an increase in the award amount for the progressive award and in response to detecting the increase in the award amount for the progressive award, update the presented representation of the state of the progressive award with an instance of the second selected symbol.

In some cases, the instructions can further cause the processor to detect an occurrence of a second predefined event within the electronic game and in response to detecting the occurrence of the second predefined event within the electronic game, update the presented representation of the state of the progressive award and the presented representation of the electronic game with an animation of the first selected symbol moving from the presented representation of the state of the progressive award to one of the plurality of features of the presented representation of the electronic game. For example, detecting the occurrence of the first predefined event can be based on a first random number, detecting the occurrence of the second predefined event can be based on a second random number, and the occurrence of the first predefined event can be more likely than the occurrence of the second predefined event.

According to yet another embodiment, a non-transitory, computer-readable medium can comprise a set of instructions stored therein which when executed by a processor, causes the processor to execute an electronic game having a progressive award and present a representation of the electronic game. The representation of the electronic game can comprise a plurality of features, each feature of the plurality of features comprising a plurality of graphical symbols. The instructions can further cause the processor to present a representation of a state of the progressive award. The representation of the state of the progressive can comprise a first selected symbol, the first selected symbol comprising a same symbol as one of the plurality of symbols of the plurality of features. A number of the first selected symbol presented in the representation of the state of the progressive award indicates an amount of time since the progressive award was last awarded.

The instructions can further cause the processor to detect an occurrence of a first predefined event within the electronic game and in response to detecting the occurrence of the first predefined event within the electronic game, update the presented representation of the state of the progressive award and the presented representation of the electronic game with an animation of the first selected symbol moving from one of the plurality of features of the presented representation of the electronic game to the presented representation of the state of the progressive award. The representation of the state of the progressive award can further comprise a second selected symbol and a number of the second selected symbol presented in the representation of the state of the progressive award can indicate an award amount for the progressive award. The instructions can further cause the processor to detect an increase in the award amount for the progressive award and in response to detecting the increase in the award amount for the progressive award, update the presented representation of the state of the progressive award with an instance of the second selected symbol.

In some cases, the instructions can further cause the processor to detect an occurrence of a second predefined event within the electronic game and in response to detecting the occurrence of the second predefined event within the electronic game, update the presented representation of the state of the progressive award and the presented representation of the electronic game with an animation of the first selected symbol moving from the presented representation of the state of the progressive award to one of the plurality of features of the presented representation of the electronic game. For example, detecting the occurrence of the first predefined event can be based on a first random number, detecting the occurrence of the second predefined event can be based on a second random number, and the occurrence of the first predefined event can be more likely than the occurrence of the second predefined event.

Additional features and advantages are described herein and will be apparent from the following Description and the figures.

### BRIEF DESCRIPTION OF THE SEVERAL VIEWS OF THE DRAWINGS

FIG. 1 is a diagram illustrating an exemplary environment in which embodiments of the present disclosure may be implemented.

FIG. 2 is an illustration of an exemplary interface for an electronic game including a presentation of persistence according to one embodiment of the present disclosure.

FIG. 3 is a block diagram illustrating additional details of components of an exemplary gaming system according to one embodiment of the present disclosure.

FIG. 4 is a flowchart illustrating an exemplary process for operating an electronic game according to one embodiment of the present disclosure.

FIG. 5 is a flowchart illustrating and exemplary process for operating an electronic game according to another embodiment of the present disclosure.

### DETAILED DESCRIPTION

Embodiments of the present disclosure are directed to providing indications of persistence in an electronic game. More specifically, embodiments of the present disclosure are directed to providing representations of a state of a progressive award, e.g,. a jackpot, of the electronic game. The representation of a state of a progressive award can persistently present an indication of an amount of time since the award was last won. The representation of a state of a progressive award can also persistently present an indication of an amount or size of the progressive award. Both of these presentations can be made in a manner that relates to the game itself, e.g., by symbols used and animations presented to update the presentations. This can build excitement about and interest in the game thereby increasing player involvement, encouraging game player, and increasing revenues of the game.

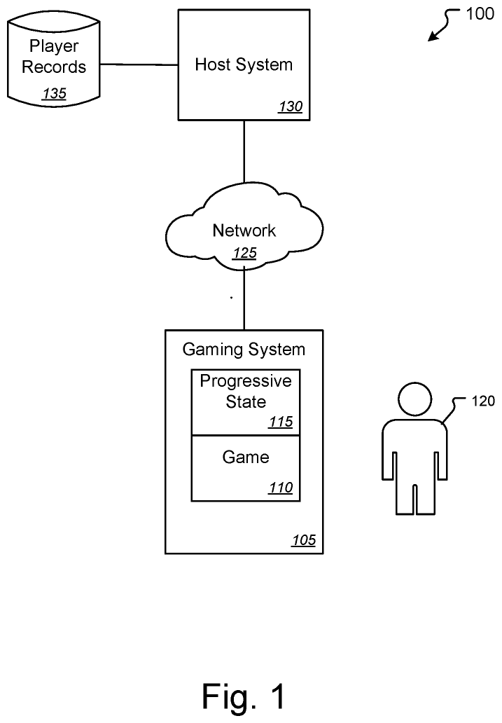

FIG. 1 is a diagram illustrating an exemplary environment in which embodiments of the present disclosure may be implemented. As illustrated in this example, the environment 100, such as may be found in a casino or other gaming venue, can include a gaming system 105 such as an Electronic Gaming Machine (EGM) or similar system. The gaming system 105 can execute any of a wide variety of electronic games including, but not limited to, slots, video poker, video keno, and/or any other such casino game. During execution of the game, the gaming system 105 can present, e.g., through a display device of the gaming system 105, a representation of the game 110 as well as a representation of a state of a progressive award 115, e.g., a jackpot, of the game. As will be described further below, the representation of a state of a progressive award 115 can be updated in a manner to present perceived persistence in two ways. First, the representation of a state of a progressive award 115 can persistently present an indication of an amount of time since the award was last won. Second, the representation of a state of a progressive award 115 can persistently present an indication of an amount or size of the progressive award. Both of these presentations can be made in a manner that relates to the game itself, e.g., by symbols used and animations presented to update the presentations. This can build excitement about and interest in the game.

As illustrated here, the gaming system 105 can be coupled with a communications network 125. The communications network 125 can comprise any one or more wired and/or wireless, local area and/or wide area networks as known in the art including, but not limited to, the Internet. Also coupled with the communications network can be a host system 130. The host system 130 can comprise any one or more servers and/or other computing devices adapted to support gaming activities within the gaming venue in which the gaming system 105 is installed. Among other things, the host system 130 can receive game play information from the gaming system 105, such as the current state an electronic game being conducted thereon and store that information in a player record 135 associated with the player 120 in order to persist information related to the game, awards won, etc.

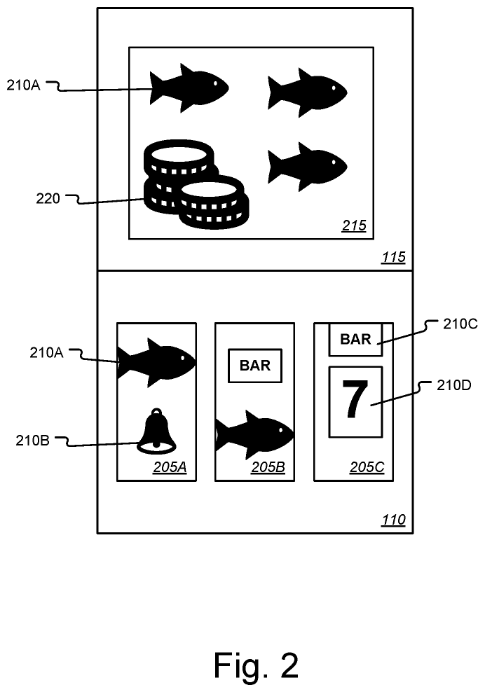

FIG. 2 is an illustration of an exemplary interface for an electronic game including a presentation of persistence according to one embodiment of the present disclosure. As illustrated in this example, the representation of the electronic game 110 can comprise a plurality of features 205A-205C with each feature of the plurality of features 205A-205C comprising a plurality of graphical symbols 210A-210D. For example, and as illustrated here, the electronic game can comprise a slots game. Thus, the plurality of features 205A-205C can comprise the reels of the slots game and the graphical symbols 210A-210D can comprise the symbols represented on the reels.

The representation of the state of the progressive award 115 can comprise a first selected symbol 210A. The first selected symbol 210A can comprise one of the plurality of symbols 210A-210D of the plurality of features 205A-205C. As illustrated in this example, a koi or fish symbol from the reels is used to provide a connection to a theme of the game. The fish symbol is present in a graphical representation of a fish tank 215, pond, or fishbowl. A number of the first selected symbol 210A presented in the representation of the state of the progressive award 115, i.e., the number of koi in the pond or tank 215, can indicates an amount of time since the progressive award was last awarded. A second selected symbol 220 can be presented which can indicate a size or dollar amount of the progressive award. An occurrence of a first predefined event within the electronic game can be detected, e.g., a koi symbol stopping on a payline for the reels. In response to detecting the occurrence of the first predefined event within the electronic game, the presented representation of the state of the progressive award 115 and the presented representation of the electronic game 110 can be updated with an animation of the first selected symbol 210A moving from one of the plurality of features 210A-210C of the presented representation of the electronic game 110 to the presented representation of the state of the progressive award 115. That is, the koi symbol stopping on the payline can be animated to jump from the reel into the fish tank 215.

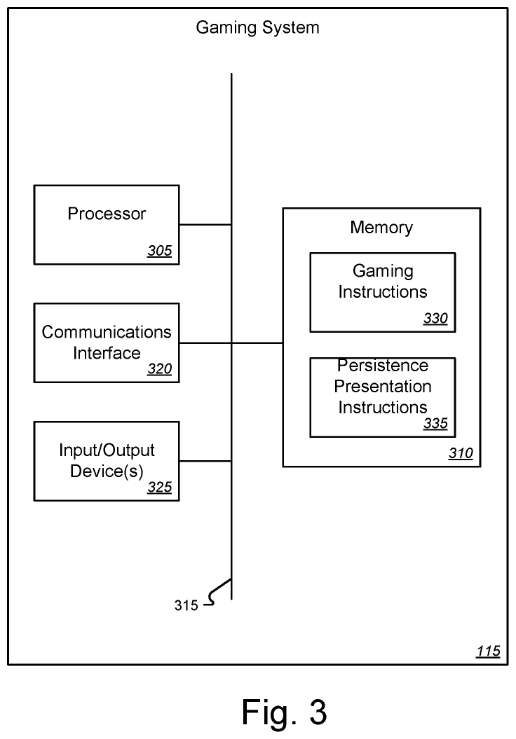

FIG. 3 is a block diagram illustrating additional details of components of an exemplary gaming system according to one embodiment of the present disclosure. As illustrated in this example, a gaming system 105 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the gaming system 105 as described herein.

The memory 210 can be coupled with and readable by the processor 205 via a communications bus 315. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communication interfaces 320 and one or more input/output devices 325 via the communications bus 315. The communication interfaces 320 can comprise, for example, a Bluetooth, WiFi, cellular, and/or other type of wireless communications interface. The input/output devices 325 can include, but are not limited to a display device such as a Liquid Crystal Display (LCD), Light Emitting Diode (LED), Organic Light Emitting Diode (OLED), or other type of display.

The memory 310 can store therein a set of gaming instructions 330 which, when executed by the processor 305, cause the processor 305 to execute an electronic game and present a representation of the game one a display device or other input/output device 325. The representation of the electronic game 110 can comprise a plurality of features, each feature of the plurality of features comprising a plurality of graphical symbols. The memory 310 can also store therein a set of persistence presentation instructions 335 which, when executed by the processor 305, causes the processor 305 to present a state of the progressive award. The representation of the state of the progressive 115 can comprise a first selected symbol, the first selected symbol comprising a same symbol as one of the plurality of symbols of the plurality of features. A number of the first selected symbol presented in the representation of the state of the progressive award 115 indicates an amount of time since the progressive award was last awarded.

The persistence presentation instructions 335 can further cause the processor 305 to detect an occurrence of a first predefined event within the electronic game and in response to detecting the occurrence of the first predefined event within the electronic game, update the presented representation of the state of the progressive award 115 and the presented representation of the electronic game 110 with an animation of the first selected symbol moving from one of the plurality of features of the presented representation of the electronic game 110 to the presented representation of the state of the progressive award 115. The representation of the state of the progressive award 115 can further comprise a second selected symbol and a number of the second selected symbol presented in the representation of the state of the progressive award 115 can indicate an award amount for the progressive award. The persistence presentation instructions 335 can further cause the processor 305 to detect an increase in the award amount for the progressive award and in response to detecting the increase in the award amount for the progressive award, update the presented representation of the state of the progressive award 115 with an instance of the second selected symbol.

In some cases, the persistence presentation instructions 335 can further cause the processor 305 to detect an occurrence of a second predefined event within the electronic game and in response to detecting the occurrence of the second predefined event within the electronic game, update the presented representation of the state of the progressive award 115 and the presented representation of the electronic game 110 with an animation of the first selected symbol moving from the presented representation of the state of the progressive award 115 to one of the plurality of features of the presented representation of the electronic game 110. For example, detecting the occurrence of the first predefined event can be based on a first random number, detecting the occurrence of the second predefined event can be based on a second random number, and the occurrence of the first predefined event can be more likely than the occurrence of the second predefined event.

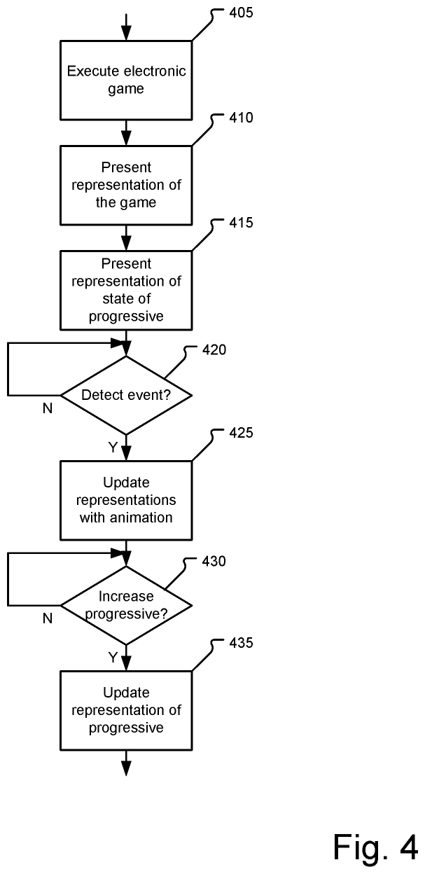

FIG. 4 is a flowchart illustrating an exemplary process for operating an electronic game according to one embodiment of the present disclosure. As illustrated in this example, operating an electronic game can comprise executing 405 an electronic game having a progressive award and presenting 410 a representation of the electronic game 110. The representation of the electronic game 110 can comprise a plurality of features with each feature of the plurality of features comprising a plurality of graphical symbols. A representation of a state of the progressive award can also be presented 415. The representation of the state of the progressive award 115 can comprise a first selected symbol. The first selected symbol can comprise a same symbol as one of the plurality of symbols of the plurality of features. A number of the first selected symbol presented in the representation of the state of the progressive award 115 can indicate an amount of time since the progressive award was last awarded. At some point during the game, an occurrence of a first predefined event within the electronic game can be detected 420. In response to detecting 420 the occurrence of the first predefined event within the electronic game, the presented representation of the state of the progressive award 115 and the presented representation of the electronic game 110 can be updated 425 with an animation of the first selected symbol moving from one of the plurality of features of the presented representation of the electronic game 110 to the presented representation of the state of the progressive award 115.

In some cases, the representation of the state of the progressive award 115 can further comprise a second selected symbol. A number of the second selected symbol presented in the representation of the state of the progressive award 115 can indicate an award amount for the progressive award. At some point during the game, an increase in the award amount for the progressive award can be detected 430. In response to detecting the increase in the award amount for the progressive award, the presented representation of the state of the progressive award 115 can be updated 435 with an instance of the second selected symbol.

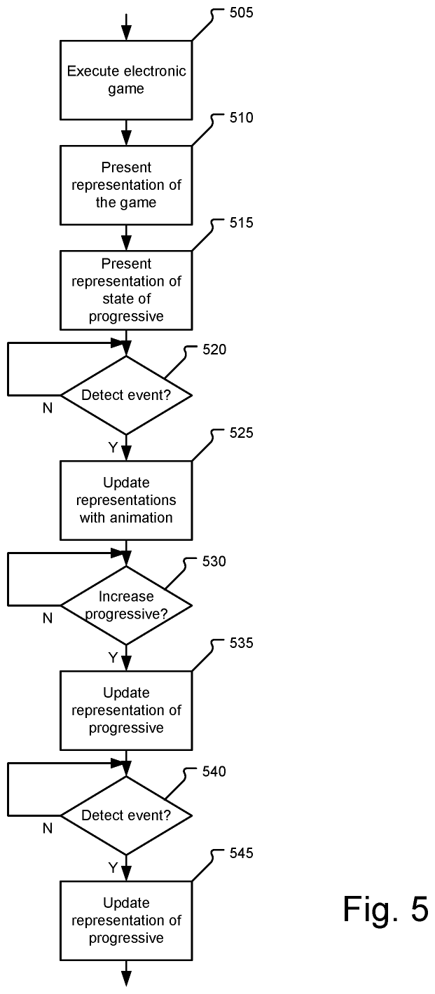

FIG. 5 is a flowchart illustrating and exemplary process for operating an electronic game according to another embodiment of the present disclosure. As illustrated in this example, operating an electronic game can comprise executing 505 an electronic game having a progressive award and presenting 510 a representation of the electronic game 110. The representation of the electronic game 110 can comprise a plurality of features with each feature of the plurality of features comprising a plurality of graphical symbols. A representation of a state of the progressive award can also be presented 515. The representation of the state of the progressive award 115 can comprise a first selected symbol. The first selected symbol can comprise a same symbol as one of the plurality of symbols of the plurality of features. A number of the first selected symbol presented in the representation of the state of the progressive award 115 can indicate an amount of time since the progressive award was last awarded. At some point during the game, an occurrence of a first predefined event within the electronic game can be detected 520. In response to detecting 520 the occurrence of the first predefined event within the electronic game, the presented representation of the state of the progressive award 115 and the presented representation of the electronic game 110 can be updated 525 with an animation of the first selected symbol moving from one of the plurality of features of the presented representation of the electronic game 110 to the presented representation of the state of the progressive award 115.

In some cases, the representation of the state of the progressive award 115 can further comprise a second selected symbol. A number of the second selected symbol presented in the representation of the state of the progressive award 115 can indicate an award amount for the progressive award. At some point during the game, an increase in the award amount for the progressive award can be detected 530. In response to detecting the increase in the award amount for the progressive award, the presented representation of the state of the progressive award 115 can be updated 535 with an instance of the second selected symbol.

In some cases, a second predefined event within the electronic game can be detected 540. In response to detecting 540 the occurrence of the second predefined event within the electronic game, the presented representation of the state of the progressive award 115 and the presented representation of the electronic game 110 can be updated 545 with an animation of the first selected symbol moving from the presented representation of the state of the progressive award 115 to one of the plurality of features of the presented representation of the electronic game 110. For example, detecting 520 the occurrence of the first predefined event is based on a first random number and detecting 540 the occurrence of the second predefined event is based on a second random number, wherein the occurrence of the first predefined event is more likely than the occurrence of the second predefined event.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating an electronic game, the method comprising:
executing, by a processor of a gaming system, an electronic game having a progressive award;
presenting, by the processor of the gaming system, a representation of the electronic game, the representation of the electronic game comprising a plurality of features, each feature of the plurality of features comprising a plurality of graphical symbols;
presenting, by the processor of the gaming system, a representation of a state of the progressive award, the representation of the state of the progressive comprising a first selected symbol, the first selected symbol comprising a same symbol as one of the plurality of symbols of the plurality of features;
detecting, by the processor of the gaming system, an occurrence of a first predefined event within the electronic game; and
in response to detecting the occurrence of the first predefined event within the electronic game, updating, by the processor of the gaming system, the presented representation of the state of the progressive award and the presented representation of the electronic game with an animation of the first selected symbol moving from one of the plurality of features of the presented representation of the electronic game to the presented representation of the state of the progressive award.

2. The method of claim 1, wherein a number of the first selected symbol presented in the representation of the state of the progressive award indicates an amount of time since the progressive award was last awarded.

3. The method of claim 2, wherein the representation of the state of the progressive award further comprises a second selected symbol, and wherein a number of the second selected symbol presented in the representation of the state of the progressive award indicates an award amount for the progressive award.

4. The method of claim 3, further comprising:
detecting, by the processor of the gaming system, an increase in the award amount for the progressive award; and
in response to detecting the increase in the award amount for the progressive award, updating the presented representation of the state of the progressive award with an instance of the second selected symbol.

5. The method of claim 1, further comprising:
detecting, by the processor of the gaming system an occurrence of a second predefined event within the electronic game; and
in response to detecting the occurrence of the second predefined event within the electronic game, updating, by the processor of the gaming system, the presented representation of the state of the progressive award and the presented representation of the electronic game with an animation of the first selected symbol moving from the presented representation of the state of the progressive award to one of the plurality of features of the presented representation of the electronic game.

6. The method of claim 5, wherein detecting the occurrence of the first predefined event is based on a first random number and wherein detecting the occurrence of the second predefined event is based on a second random number.

7. The method of claim 6, wherein the occurrence of the first predefined event is more likely than the occurrence of the second predefined event.

8. A system comprising:
a display device;
a processor coupled with the display device;
a memory coupled with and readable by the processor and having stored therein a set of instructions which, when executed by the processor, causes the processor to:
execute an electronic game having a progressive award;
present a representation of the electronic game, the representation of the electronic game comprising a plurality of features, each feature of the plurality of features comprising a plurality of graphical symbols;
present a representation of a state of the progressive award, the representation of the state of the progressive comprising a first selected symbol, the first selected symbol comprising a same symbol as one of the plurality of symbols of the plurality of features;
detect an occurrence of a first predefined event within the electronic game; and
in response to detecting the occurrence of the first predefined event within the electronic game, update the presented representation of the state of the progressive award and the presented representation of the electronic game with an animation of the first selected symbol moving from one of the plurality of features of the presented representation of the electronic game to the presented representation of the state of the progressive award.

9. The system of claim 8, wherein a number of the first selected symbol presented in the representation of the state of the progressive award indicates an amount of time since the progressive award was last awarded.

10. The system of claim 9, wherein the representation of the state of the progressive award further comprises a second selected symbol, and wherein a number of the second selected symbol presented in the representation of the state of the progressive award indicates an award amount for the progressive award.

11. The system of claim 10, wherein the instructions further cause the processor to:
detect an increase in the award amount for the progressive award; and
in response to detecting the increase in the award amount for the progressive award, update the presented representation of the state of the progressive award with an instance of the second selected symbol.

12. The system of claim 8, wherein the instructions further cause the processor to:
detect an occurrence of a second predefined event within the electronic game; and
in response to detecting the occurrence of the second predefined event within the electronic game, update the presented representation of the state of the progressive award and the presented representation of the electronic game with an animation of the first selected symbol moving from the presented representation of the state of the progressive award to one of the plurality of features of the presented representation of the electronic game.

13. The system of claim 12, wherein detecting the occurrence of the first predefined event is based on a first random number and wherein detecting the occurrence of the second predefined event is based on a second random number.

14. The system of claim 13, wherein the occurrence of the first predefined event is more likely than the occurrence of the second predefined event.

15. A non-transitory, computer-readable medium comprising a set of instructions stored therein which when executed by a processor, causes the processor to:
execute an electronic game having a progressive award;
present a representation of the electronic game, the representation of the electronic game comprising a plurality of features, each feature of the plurality of features comprising a plurality of graphical symbols;
present a representation of a state of the progressive award, the representation of the state of the progressive comprising a first selected symbol, the first selected symbol comprising a same symbol as one of the plurality of symbols of the plurality of features;
detect an occurrence of a first predefined event within the electronic game; and
in response to detecting the occurrence of the first predefined event within the electronic game, update the presented representation of the state of the progressive award and the presented representation of the electronic game with an animation of the first selected symbol moving from one of the plurality of features of the presented representation of the electronic game to the presented representation of the state of the progressive award.

16. The non-transitory, computer-readable medium of claim 15, wherein a number of the first selected symbol presented in the representation of the state of the progressive award indicates an amount of time since the progressive award was last awarded.

17. The non-transitory, computer-readable medium of claim 16, wherein the representation of the state of the progressive award further comprises a second selected symbol, and wherein a number of the second selected symbol presented in the representation of the state of the progressive award indicates an award amount for the progressive award.

18. The non-transitory, computer-readable medium of claim 17, wherein the instructions further cause the processor to:
detect an increase in the award amount for the progressive award; and
in response to detecting the increase in the award amount for the progressive award, update the presented representation of the state of the progressive award with an instance of the second selected symbol.

19. The non-transitory, computer-readable medium of claim 15, wherein the instructions further cause the processor to:
detect an occurrence of a second predefined event within the electronic game; and
in response to detecting the occurrence of the second predefined event within the electronic game, update the presented representation of the state of the progressive award and the presented representation of the electronic game with an animation of the first selected symbol moving from the presented representation of the state of the progressive award to one of the plurality of features of the presented representation of the electronic game.

20. The system of claim 19, wherein detecting the occurrence of the first predefined event is based on a first random number, wherein detecting the occurrence of the second predefined event is based on a second random number, and wherein the occurrence of the first predefined event is more likely than the occurrence of the second predefined event.
